(19) United States
(12) Patent Application Publication
(10) Pub. No.: US 2017/0243463 A1
(43) Pub. Date: Aug. 24, 2017

(54) SYSTEMS, METHODS, AND DEVICES FOR USING A CODE TO TRACK TASK COMPLETION

(71) Applicant: GRZ Pharma, LLC, Trumbull, CT (US)

(72) Inventor: Grzegorz Rdzak, Trumbull, CT (US)

(21) Appl. No.: 15/046,842

(22) Filed: Feb. 18, 2016

(51) Int. Cl. G08B 21/24; G06K 7/10; G06K 7/14; G06Q 10/10

(52) U.S. Cl. CPC G08B 21/24; G06Q 10/1097; G06K 7/10722; G06K 7/1413; G06K 7/1417

(57) ABSTRACT

Embodiments of the present disclosure include systems, devices and methods for using a code to track task completion. Embodiments include receiving, by a user computing device, a code selection user input from a user interface of the user computing device. Further, embodiments include selecting, by the user computing device, a code for a task from a code repository based on the code selection user input. In addition, embodiments include scanning the code using at least one of a scanning module and an image capture device of the user computing device. Moreover, embodiments include receiving, by the user computing device, assignment information from the user interface for the code. Also, embodiments include assigning, by the user computing device, a task for the code based on the assignment information. Further, embodiments include storing, by the user computing device, the code with the assignment information and task in a database.

### BACKGROUND

Many different people may need to complete tasks within a time period. For example, in many families, a person may be required to take several different medications each at a different time. Taking a regimen of such medication may be taxing to the memory of the person. Not only does the person need to remember to take the medication so as to not miss a dose, but also remember to have already taken the medication so as to not take an additional dose.

Many reminder and note taking devices have existed to assist a person to remember taking medication and account for medication already taken. These include alarm clocks, medication logging devices, etc. Although these devices assist in part in reminding or logging medication consumption/intake, these devices have several drawbacks. These include remembering to program an alarm in a clock or electronic calendar. With such a device, a person merely exchanges remembering to take medication with remembering to program the reminder. Thus, the remembering is simply placed further upstream without providing any benefit to the person. Another drawback to such devices is that logging medication consumption/intake can be cumbersome. Any mobile phone application would require the person to enter the medication information manually which may be tedious and time-consuming.

Further, not only is it cumbersome and tedious to remember and log medication intake, but also cumbersome to track tasks that need to be performed on a periodic basis. Thus, there is a need for systems, methods, and devices for using a code to track task completion.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a functional block diagram of a system for using a code to track task completion, according to some embodiments.

FIGS. 2-3 are a functional block diagrams of devices for using a code to track task completion, according to some embodiments.

FIGS. 4A-4F are flowcharts of methods for using a code to track task completion, according to some embodiments.

FIG. 5 is a flowchart of a method for generating a code used to track task completion, according to some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

The illustrative embodiments described in the detailed description, drawings, and claims are not meant to be limiting. Other embodiments may be utilized, and other changes may be made, without departing from the scope of the subject matter presented herein. It will be readily understood that the aspects of the present disclosure, as generally described herein, and illustrated in the Figures, can be arranged, substituted, combined, separated, and designed in a wide variety of difference configurations, all of which are explicitly contemplated herein. Further, in the foregoing description, numerous details are set forth to further describe and explain one or more embodiments. These details include system configurations, block module diagrams, flowcharts (including transaction diagrams), and accompanying written description. While these details are helpful to explain one or more embodiments of the disclosure, those skilled in the art will understand that these specific details are not required in order to practice the embodiments.

As will be appreciated by one skilled in the art, aspects of the present disclosure may be embodied as an apparatus that incorporates some software components. Accordingly, some embodiments of the present disclosure, or portions thereof, may combine one or more hardware components such as microprocessors, microcontrollers, or digital sequential logic, etc., such as processor with one or more software components (e.g., program code, firmware, resident software, micro-code, etc.) stored in a tangible computer-readable memory device such as a tangible computer memory device, that in combination form a specifically configured apparatus that performs the functions as described herein. These combinations that form specially-programmed devices may be generally referred to herein as “modules”. The software component portions of the modules may be written in any computer language and may be a portion of a monolithic code base, or may be developed in more discrete code portions such as is typical in object-oriented computer languages. In addition, the modules may be distributed across a plurality of computer platforms, servers, terminals, mobile devices and the like. A given module may even be implemented such that the described functions are performed by separate processors and/or computing hardware platforms.

Although medication consumption/intake is an example of a task described herein, persons of ordinary skill in the art would understand that the systems, devices, and methods described in the pending disclosure may be used to track completion of any task.

Embodiments of the present disclosure include systems, devices, and methods for using a code to track task completion. These may include receiving, by a user computing device, a code selection user input from a user interface of the user computing device. Further, such systems, devices, and methods may include selecting, by the user computing device, a code for a task from a code repository based on the code selection user input. In addition, such systems, devices, and methods may include scanning the code using a scanning module or an image capture device of the user computing device. Moreover, such systems, devices, and methods may include receiving, by the user computing device, assignment information from the user interface for the code. Also, such systems, devices, and methods may include assigning, by the user computing device, a task for the code based on the assignment information. Further, such systems, devices, and methods may include storing, by the user computing device, the code with the assignment information and task in a database.

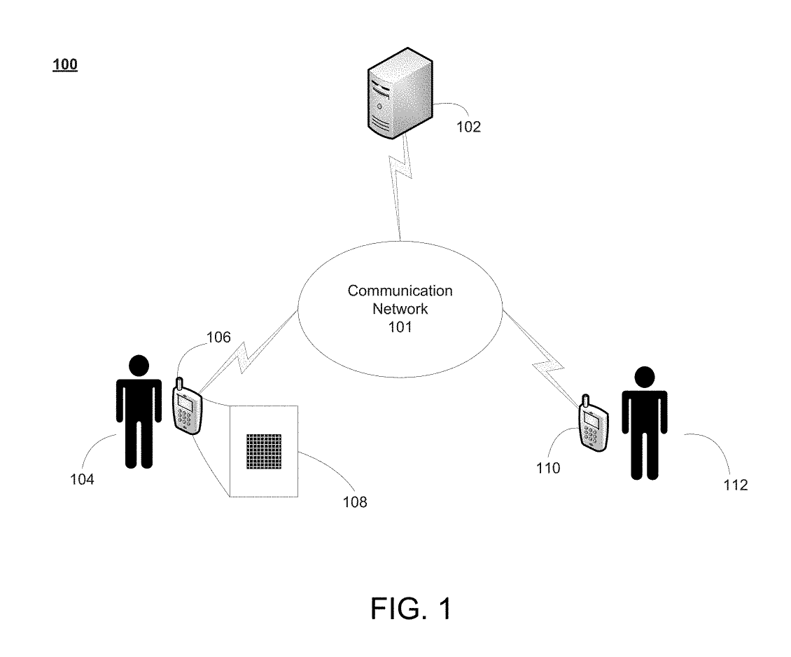

FIG. 1 is a functional block diagram of a system 100 for using a code 108 to track task completion, according to some embodiments. The system 100 includes a user 104 having a user mobile device 106. Such a user mobile device 106 may interact with a computer server 102 over a communication network 101. Further, a caregiver 112 may have a caregiver mobile device 110 that interacts with a user mobile device 106 over the communication network 101 with or without communicating through the computer server 102.

In one embodiment, a user may desire to use a code 108 to track completion of a task. Such a code 108 may be a Quick Response (QR) code, bar code, any character string, alphanumeric string, graphical, textual, or any other type of code. Further, a mobile application on the user mobile device 106 may be able to access a code repository that stores a plurality of codes for tracking task completion. Such a code repository may be stored on the user mobile device 106 or in a remote database/server 102 accessed by the user mobile device 106 over the communication network 101. In addition, such a mobile application may include one or more modules implemented by one or more processors that are specialized components of the user computing device 106. In other embodiments, such modules may be incorporated in the remote computer server 102 and implement the functions to track completion of a task as described herein. This allows the functionality to be implemented by the computer server 102 and not by the limited resources (e.g. processor capacity, memory, etc.) of the user mobile device 106.

Further, a code 108 may be selected by the user 104 from the user mobile device 106. The user 104 may enter user input into the user interface of a mobile application on the user mobile device 106. The mobile application may be one or more modules described herein, parts of which are stored or implemented by the user mobile device 106. Based on the user input, the mobile application on the user mobile device 106 may select a code 108 from the code repository. Upon selecting the code 108, the mobile application may prompt the user 106 to print or otherwise render physically the code 108. Further, the user 104 may be prompted by the mobile application to scan the code 108. The user 104 may scan the code 108 using an image capture device such as a camera or other code scanning mechanism or module (e.g. bar code reader, QR code reader, etc.) on the user mobile device 106. In addition, the mobile application on the user mobile device 106 may prompt the user 104 to enter assignment/task information for the code 108. For example, the user 104 may enter that the code 108 is used to track a medication consumption/intake task by the user 104 such that the user must take a daily dose of medication in the time period between 4 pm-6 pm. Another example may be that the user 104 enters that the code 108 to track whether the task of watering the plants is completed. Thereafter, the mobile application assigns the task to the code 108 based on the assignment information. That is, the assignment information may include the task. In addition, the mobile application may store the code 108 with the assignment information and associated task. Such stored information may be on the user mobile device or on a remote computer server/database 102.

In a further embodiment, a user may want to track completion of a task. Thus, the user may complete the task and then scan a code 108 using a user mobile device 106. The mobile application on the user mobile device 106 determines the task based on the scanned code 108. Further, the mobile application stores an indication that the task is complete. This stored data may be on the user mobile device 106 or in the remote computer server/database 102. The indication may be a recorded log that the task is complete that includes text or some other user input. Alternatively, or in addition to, the indication may include data designating the task as complete by mechanisms known in the art. Moreover, the user mobile device 106 or the remote computer server/database 102 may send a notification to the caregiver 112 on the caregiver mobile device 110. For example, the task may be for the user 104 to take daily dose of medication. The physical code 108 may be beside or adhered to a medication container. Immediately prior to or immediately after the medication is taken and the code 108 is scanned by the user 104, an indication is stored that the task is complete and a notification of such may be sent to a caregiver 112 e.g. a physician, family member, nurse, health care professional, etc.

In another embodiment, a user 104 may scan a code 108 to determine whether the task associated with the code 108 has been completed. For example, the physical code 108 may be beside or adhered to a medication container. The user 104 task may to take a dose of medication daily. However, the user 104 may not remember whether he/she has taken the medication on a given day. Thus, prior to taking the medication, the user 104 may scan the code 108 to determine whether the task was completed during the time period associated with the task. The mobile application on the user mobile device 106 determines the task based on the scanned code 108. Further, the mobile application determines whether the task has been completed based on a previous stored indication and the assignment information. Depending on such determination, the mobile application provides an alert indicating that the task has already, or has not, been completed.

In an additional embodiment, a mobile application on the user mobile device 106 determines a time period for the task to be completed based on the assignment information by the user 104. That is, the time period to complete the task may be included in the assignment information. The mobile application tracks the time period and determines that the time period has elapsed. At which the mobile application provides an alert to the user 104 via the user interface on the user mobile device 104 that indicates the time period to complete the task has elapsed. In addition, the mobile application may send a warning alert to the caregiver 112 that the time period for user 104 to complete the task has elapsed. For example, a user 104 may have configured with the mobile application a task for taking a daily dose of medication between 4 pm to 6 pm each day. However, at 6 pm on a given day, the mobile application does not receive a scanned code 108 or any user input instructing the mobile application that the task has been completed. Thus, the mobile application determines that the time period to complete the task has elapsed and provides an alert to the user 104 and a warning alert to the caregiver 112 as a reminder to each that the user has not completed the task of taking daily medication.

In a further embodiment, the user may want to update or change the assignment/task information associated with a code 108. The mobile application on the user mobile device 106 selects the code 108 for the task based on the updated/changed code 108 selection user input. Further, the mobile application receives updated/changed assignment information from the user 104 as user input. The mobile application updates the task for the case based on the updated/changed assignment information. In addition, the mobile application stores the code 108 with the updated/changed assignment information and/or updated/changed task either on the user mobile device 106 or on the remote computer server/database 102.

In a further embodiment, the user 104 may want to make his/her own code. The code may be any alpha numeric text, graphical symbol, or captured image. Thus, the mobile application on the user mobile device 106 may receive code generation user input from the user interface or image capture device of an alphanumeric text, graphical symbol, or captured image. Further, the mobile application may generate a code based on the code generation user input. Such a code may be stored in the code repository, either on the user mobile device or on the remote computer server/database.

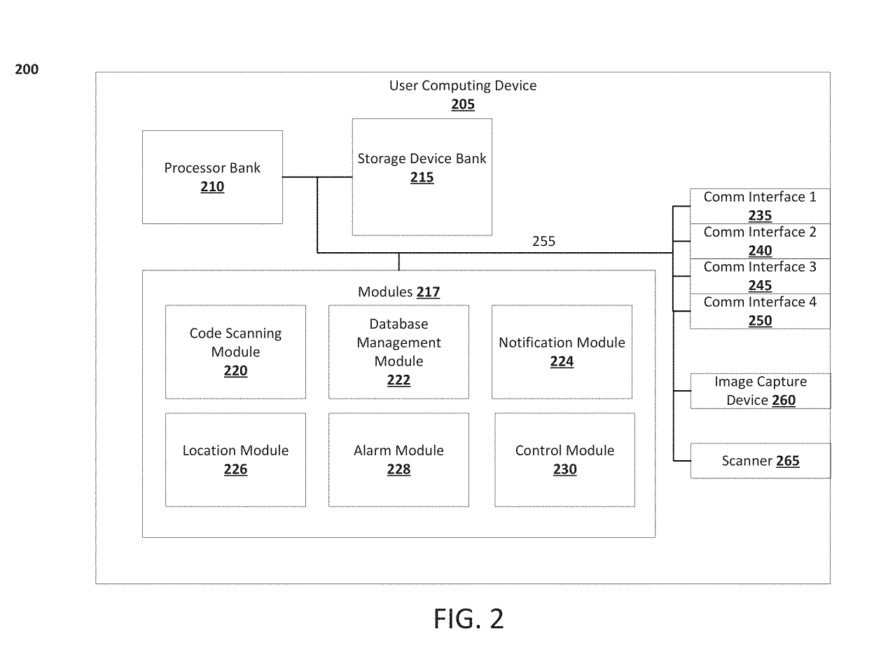

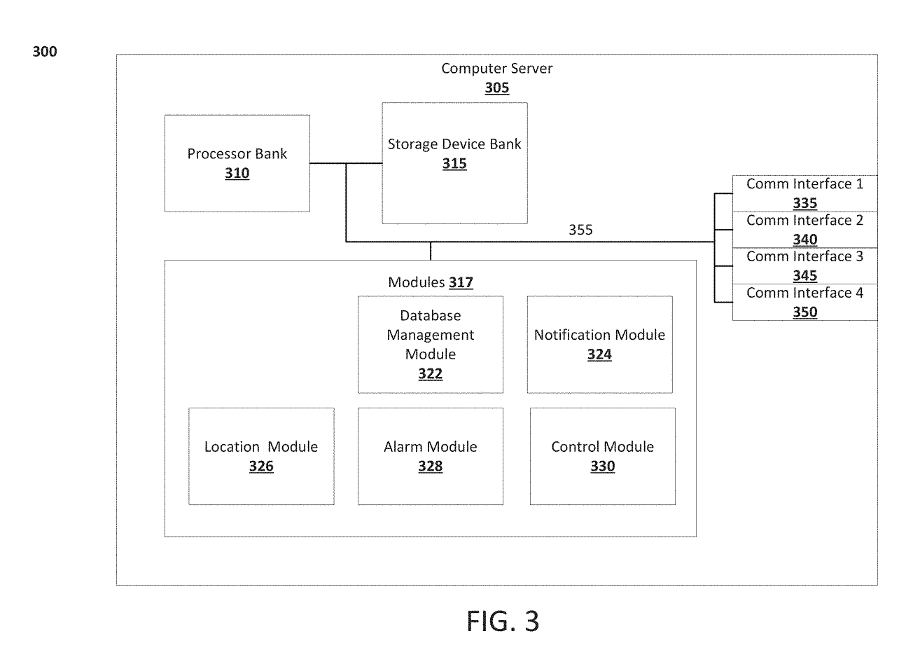

FIGS. 2-3 are a functional block diagrams of devices for using a code to track task completion, according to some embodiments. Referring to FIG. 2, a user computing device 205 is shown and may be used in a system shown in FIG. 1 as user mobile device. However, the user computing device 205 may be, but not limited to, a smartphone, tablet computer, desktop computer, laptop computer, smartwatch, or any other computing device. The user computing device 205 may include several different components such as a processor bank 210, storage device bank 215, one or more software applications, which may be executed by a processor. Thus, the combination of the software applications as well as the processor and any other hardware form specifically-configured modules 217 that are specialized components of the user computing device 205. The user computing device 205 also has one or more communication interfaces (235-250) as well as an image capture device 260 such as a camera and scanner 265 such as a bar code scanner, QR code scanner, or any other scanner known in the art. The processor bank 210 may include one or more processors that may be co-located with each other or may be located in different parts of the user computing device 205. The storage device bank 215 may include one or more storage devices. Types of storage devices may include electronic memory, optical memory, and removable storage media. The one or more modules 217 may include, but are not limited to, a code scanning module 220, a database management module 222, a notification module 224, a location module 226, an alarm module 228, and a control module 230. The modules 217 may be implemented by the one or more processors in the processor bank 210.

The code scanning module 220 receives a scanned code either from the image capture device 260 or scanner 265. The scanned code may be used in assigning a task for the code. Further, the scanned code may be associated with a task. In addition, the scanned code may be used to indicate a task is complete. Moreover, the scanned code may be used to update or change the task/assignment information associated with the scanned code. Once the scanned code is processed, the processed code data is transmitted to another module 217 such as the database management module 222. For example, the scanned code 108 may be a QR code. The code scanning module 220 may process the scanned code decode or associate it to alphanumeric text. Such alphanumeric text may be sent to the database management module 222.

The database management module 222 receives data from the code scanning module 220 or a user interface (e.g. one of the communication interfaces (235-250) may be a user interface). In an embodiment, the database management module 222 receives code selection user input from the user interface. The database management module 222 selects a code from the code repository based on the code selection user input. Further, the database management module 222 may receive assignment information from the user interface. In addition, the database management module 222 assigns a task for the code based on the assignment information. Also, the database management module 222 stores the code (or the processed code data) with the assignment information and task in a database either in the storage device bank 215 or in a remote computer server/database. Thus, the code or processed code data, assignment information, and task are associated with each other in the database. When storing this information, the code may be converted or transformed from a code data structure into alphanumeric data structure and then into database data structure. Further, assignment information and task may be in a user interface data structure then converted or transformed into a database data structure when stored in the database.

In another embodiment, the database management module 222 receives a scanned code or processed code data from the code scanning module 220. The database management module 222 accesses the database (either stored in the storage device bank 215 or in the remote computer server/database) to determine the task based on the code. Further, the database management module 222 stores an indication that the task is complete in the database. The indication may be simply toggling a parameter in the database to indicate that the task was complete. For example, the parameter may simply be labeled as “complete?” and can be toggled from “Yes” to “No” as an indication the that the task has been completed. Persons of ordinary skill in the art would understand that other mechanisms may be used in the database to indicate that the task was complete. In addition, the database management module 222 may send a trigger signal to the notification module 224 to send a notification to a caregiver that the task has been completed.

In a further embodiment, the database management module 222 receives a scanned code, or processed code data, from the code scanning module 220 and accesses the database to determine the task based on the code or processed code data. Accessing the database may include converting data from the database from a database data structure into another processing data structure to make certain determinations such as the which task is assigned to the code Further, the database management module 222 determines the task has been completed based on a previously stored indication in the database and/or assigned information. In addition, the database management module 222 may send a trigger signal to the notification module 224 to send a notification to the user via the user interface that the task has already been completed.

In an additional embodiment, the database management module 222 receives updated or changed code selection user input from the user interface. Upon receipt, the database management module 222 selects a code for the task based on the updated or changed code selection user input. Further, the database management module 222 receives updated or changed assignment information regarding the task associated with the code. In addition, the database management module 222 updates or changes the task for the code based on the updated or changed assignment information. Also, the database management module 222 stores the updated or changed assignment information and updated or changed task in the database.

In another embodiment, the database management module 222 may receive a user generated code from the code scanning module or the user interface. Upon receipt, the database management module 222 stores the user generated code in the code repository. For example, the user may capture an image of a container for medication and use this capture image as a code that is assigned the task of taking the medication.

The notification module 224 sends notification or alerts to either the user via the user interface or to a third party such as a caregiver to the caregiver computing device. The notifications and alerts may be, but not limited to, email messages, text messages, voice messages, or any other data messages known in the art. In one embodiment, the notification module 224 may receive a trigger signal from the database management module 222 that a task has been completed. Based on such a trigger signal, the notification module 224 may send a notification to the user via the user interface or to the caregiver computing device. In another embodiment, the notification module 224 may receive a trigger signal or data indicating that the task has already been completed. Thus, the notification module 224 may provide an alert or notification to the user via the user interface indicating that the task has been completed. In a further embodiment, the notification module 224 receives a trigger signal from the alarm module 228 indicating a time period has elapsed and that a task has not been completed. Upon receipt, the notification module 224 send an alert to the user via the user interface indicating the time period to complete the task has elapsed. Further, the notification module 224 may send a warning alert to the caregiver computing device indicating that the time period to complete a task has elapsed.

The alarm module 228 receives from the database management module 222 the assignment information or a portion thereof. Further, the alarm module 228 determines a time period for the task to be completed based on the assignment information or portion thereof. Further, the alarm module 228 determines that the time period has elapsed and provides a trigger signal to the notification module 224 to send an alert that the time period to complete the task has elapsed to the user via the user interface and/or to a caregiver computing device of the same.

The location module 226 determines the location of the user computing device 205 based on global positioning systems known in the art. In one embodiment, when a user scans a code to complete a task, the location module 226 may record the location of the user computing device 205 at such a time instant as the location of the code or task to be completed. Further, the location module 226 may periodically determine (configurable by the user 104 using the mobile application or based on a default value) the location of the user computing device 205 and determine the amount of travel time to reach the location of the code or task using known methods, devices, and system in the art (e.g. mapping applications or programs). This travel time may be transmitted to the alarm module 228 to adjust the alarm for an elapsed time period to complete a task. For example, the location module 226 may determine that a user computing device may be 15 minutes of travel time from the location of the code or task at 5:40 pm. The time period to complete the task may be from 4 pm to 6 pm. The location module may send the alarm module 228 that the user computing device is 15 minutes of travel time from the code or task. Consequently, the alarm module 228 may adjust the time period based on the travel time such that the alarm module determines the time period is elapsed at 5:45 pm instead of 6 pm and indicates the travel time to user 104 via the user interface. In other embodiments, the location module 226 and alarm module 228 may be configured to provide reminders to the user 104 via the user interface at one or more time intervals prior to the elapsed time period.

The control module 230 includes software and hardware functions that assist in performing certain tasks for the user computing device 205 such as providing access to a communication link (e.g. wired, wireless, Bluetooth, infra-red, RF, etc.), executing an operating system, managing software drivers for peripheral components, and processing information. In addition, the control module 230 may also include software drivers for peripheral components, user interface computer programs, debugging and troubleshooting software tools. Also, the control module 230 may include an operating system. Such operating systems are known in the art for user computing device 205 but may also include computer operating systems (e.g. Windows, Linux, UNIX, and MacOS, etc.).

Each of the communication interfaces (235-250) may be software or hardware associated in communicating to other devices. The communication interfaces (235-250) may be of different types that include a user interface, USB, Ethernet, WiFi, wireless, optical, cellular, or any other communication interface coupled to a communication network. One or more of the communication interfaces (235-250) may be coupled to a user interface known in the art.

An intra-device communication link 255 between the processor bank 210, storage device bank 215, modules 217, and communication interfaces (235-250) may be one of several types that include a bus or other communication mechanism.

Referring to FIG. 3, a computer server 305 is shown and may be used in a system shown in FIG. 1. The computer server 305 and any other server described in the present disclosure may include a database stored in a storage device bank or may be coupled to a remote database. Further, such a computer server may be part of a computer server system described herein that may include one or more computer servers and one or more databases. In the present disclosure, a computer server may, but not always, refer to embodiments that include a computer server system having one or more computer servers and one or more databases coupled to each other. The one or more computer servers may be co-located with each other or distributed among different locations. Likewise, the one or more one or more databases may be co-located with each other or distributed among different locations. In further embodiments, some of the one or more computer servers may be co-located and coupled to the one or more databases while in additional embodiments some of the one or more computer servers may be coupled to the one or more databases each of which are placed in different location. In still further embodiments, a computer server system may refer to at least one of a computer server and a database. The components shown in FIGS. 1 and 3 may be located in one computer server or be distributed among more than one computer server and/or databases.

The computer server 305 may include several different components such as a processor bank 310, storage device bank 315, one or more software applications, which may be executed by a processor. Thus, the combination of the software applications as well as the processor and any other hardware form specifically-configured modules 317 that are specialized components of the computer server 305. The computer server 305 also has one or more communication interfaces (335-350). The processor bank 210 may include one or more processors that may be co-located with each other or may be located in different parts of the computer server 305. The storage device bank 315 may include one or more storage devices. Types of storage devices may include electronic memory, optical memory, and removable storage media. The one or more modules 317 may include, but are not limited to, database management module 322, notification module 324, location module 326, alarm module 328, and control module 330. The modules 317 may be implemented by the one or more processors in the processor bank 310. Further, the named modules 317 in FIG. 3 have similar functionality as those identically named in FIG. 2. In an embodiment, the computer server 305 receives the code, user input, and GPS location information from a user computing device and processes such information in a similar manner as the identically named modules in FIG. 2. However, in this embodiment, all the processing is done on the computer server 305, possibly in a cloud server environment, thereby allowing the user computing device to use less resources (e.g. processor capacity, memory, etc.) than the embodiment shown and discussed in FIG. 2.

The database management module 322 receives data, such as a scanned code, processed code data, or user input, from a user computing device. In an embodiment, the database management module 322 receives code selection user input from the user computing device. The database management module 322 selects a code from the code repository based on the code selection user input. Further, the database management module 322 may receive assignment information as user input from the user computing device. In addition, the database management module 322 assigns a task for the code based on the assignment information. The task may be included in the assignment information. Also, the database management module 322 stores the code with the assignment information and task in a database in the storage device bank 315. The storing of this information in the database may include converting or transforming the information from a user interface data structure to a database data structure. Further, the user computing device may provide the code or processed data from the code (as described herein) in one data structure and the database management module 322 may convert or transform code or processed data into a database data structure.

In another embodiment, the database management module 322 receives a scanned code, or processed code data, from the user computing device. The database management module 322 accesses the database to determine the task based on the code. Further, the database management module 322 stores an indication that the task is complete in the database. The indication may be simply toggling a parameter in the database to indicate that the task was complete. For example, the parameter may simply be labeled as “complete?” and can be toggled from “Yes” to “No” as an indication the that the task has been completed. Persons of ordinary skill in the art would understand that other mechanisms may be used in the database to indicate that the task was complete. In addition, the database management module 322 may send a trigger signal to the notification module 324 to send a notification to a caregiver that the task has been completed.

In a further embodiment, the database management module 322 receives a scanned code or processed code data from the user computing device and accesses the database to determine the task based on the code. Accessing the database may include converting data from the database from a database data structure into another processing data structure to make certain determinations such as the which task is based on the code Further, the database management module 322 determines the task has been completed based on a previously stored indication in the database and/or assigned information. In addition, the database management module 322 may send a trigger signal to the notification module 324 to send a notification to the user via the user interface that the task has already been completed.

In an additional embodiment, the database management module 322 receives updated or changed code selection as user input from the user computing device. Upon receipt, the database management module 322 selects a code for the task based on the updated or changed code selection user input. Further, the database management module 322 receives updated or changed assignment information from the user computing device regarding the task associated with the code. In addition, the database management module 322 updates or changes the task for the code based on the updated or changed assignment information. Also, the database management module 322 stores the updated or changed assignment information and updated or changed task in the database. For example, a code associated with the task of taking medication once daily between 4 pm-6 pm may be updated to be taken twice daily, once at 8 am-10 am and the other at 4 pm-6 pm. In another example, the task associated with the code may be changed such that the task of taking medication associated with the code is changed to watering plants.

In another embodiment, the database management module 322 may receive a user generated code from the user computing device. Upon receipt, the database management module 322 stores the user generated code in the code repository. For example, the user may capture an image of a container for medication and use this capture image as a code that is assigned the task of taking the medication.

The notification module 324 sends notification or alerts to either the user via the user interface of the user computing device or to a third party such as a caregiver via the user interface the caregiver computing device. The notifications and alerts may be, but not limited to, email messages, text messages, voice messages, or any other data messages known in the art. In one embodiment, the notification module 324 may receive a trigger signal or data from the database management module 322 that a task has been completed. Based on such a trigger signal, the notification module 324 may send a notification to the user computing device or to the caregiver computing device via their respective user interfaces. In another embodiment, the notification module 324 may receive a trigger signal indicating that the task has already been completed. Thus, the notification module 324 may provide an alert or notification to the user via the user interface indicating that the task has been completed. In a further embodiment, the notification module 324 receives a trigger signal from the alarm module 328 indicating a time period has elapsed and that a task has not been completed. Upon receipt, the notification module 324 send an alert to the user via the user interface indicating the time period to complete the task has elapsed. Further, the notification module 324 may send a warning alert to the caregiver computing device via its respective user interface indicating that the time period to complete a task has elapsed.

The alarm module 328 receives from the database management module 322 the assignment information or a portion thereof. Further, the alarm module 328 determines a time period for the task to be completed based on the assignment information or portion thereof. For example, the task may be taking medication between the time period of 4 pm-6 pm. In addition, the alarm module 328 determines that the time period has elapsed and provides a trigger signal to the notification module 324 to send an alert to the user via the user interface that the time period to complete the task has elapsed and/or a warning alert to the user interface of the caregiver computing device of the same.

The location module 326 receives the location of the user computing device 205 based on global positioning systems known in the art. In one embodiment, when a user scans a code to complete a task, the location module 326 may receive and record the location of the user computing device at that time instant as the location of the code or task to be completed. Further, the location module 326 may periodically determine the location of the user computing device and determine the amount of travel time to reach the location of the code or task using known methods, devices, and system in the art. This travel time may be transmitted to the alarm module 328 to adjust the alarm for an elapsed time period to complete a task. For example, a user computing device may be 15 minutes of travel time from the location of the code or task at 5:40 pm. The time period to complete the task may be from 4 pm to 6 pm. The location module may send the alarm module 328 that the user computing device is 15 minutes of travel time from the code or task. Consequently, the alarm module 328 may adjust the time period based on the travel time such that the alarm module determines the time period is elapsed at 5:45 pm instead of 6 pm and indicates the travel time. In other embodiments, the location module 226 and alarm module 228 may be configured to provide reminders to the user 104 via the user interface at one or more time intervals prior to the elapsed time period.

The control module 330 includes software and hardware functions that assist in performing certain tasks for the computer server 305 such as providing access to a communication link (e.g. wired, wireless, Bluetooth, infra-red, RF, etc.), executing an operating system, managing software drivers for peripheral components, and processing information. In addition, the control module 330 may also include software drivers for peripheral components, user interface computer programs, debugging and troubleshooting software tools. Also, the control module 330 may include an operating system. Such operating systems are known in the art for computer server 305 but may also include computer operating systems (e.g. Windows, Linux, UNIX, and MacOS, etc.).

Each of the communication interfaces (335-350) may be software or hardware associated in communicating to other devices. The communication interfaces (335-350) may be of different types that include a user interface, USB, Ethernet, WiFi, WiMax, wireless, optical, cellular, or any other communication interface coupled to a communication network. One or more of the communication interfaces (335-350) may be coupled to a user interface known in the art.

An intra-device communication link 355 between the processor bank 310, storage device bank 315, modules 317, and communication interfaces (335-350) may be one of several types that include a bus or other communication mechanism.

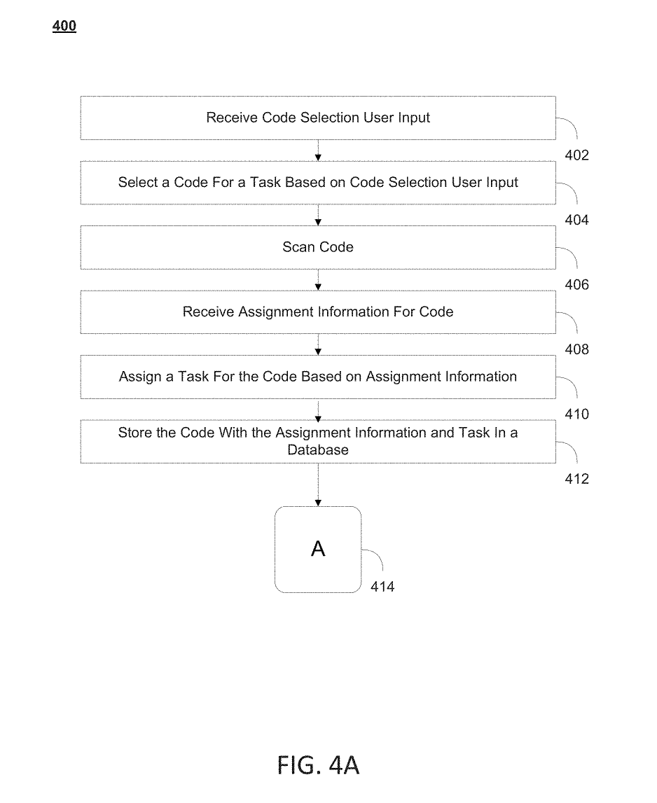

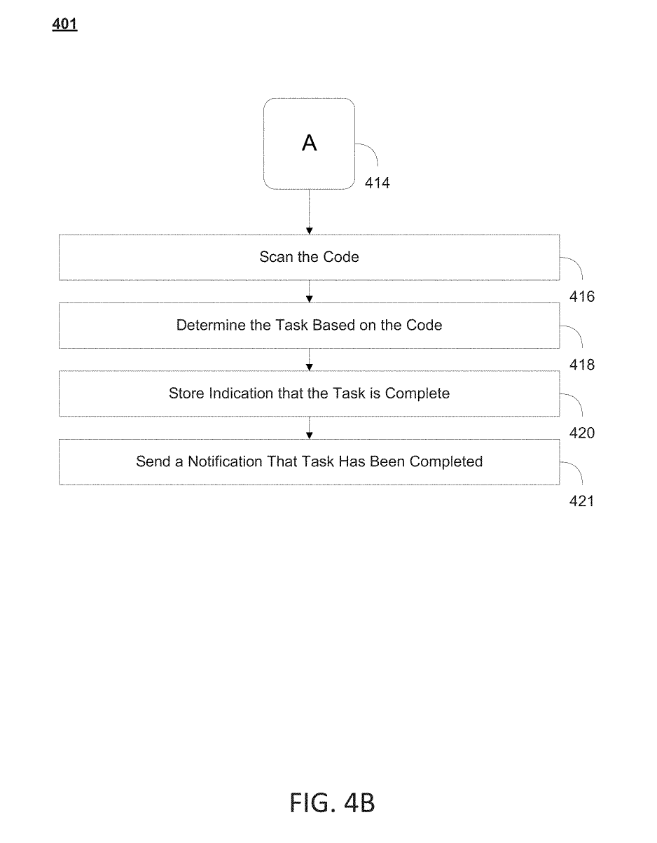

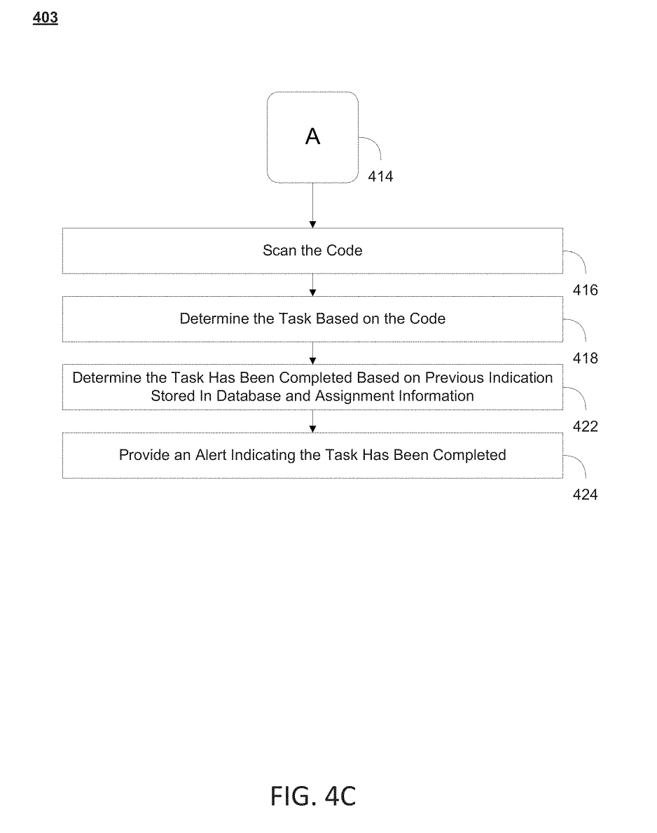

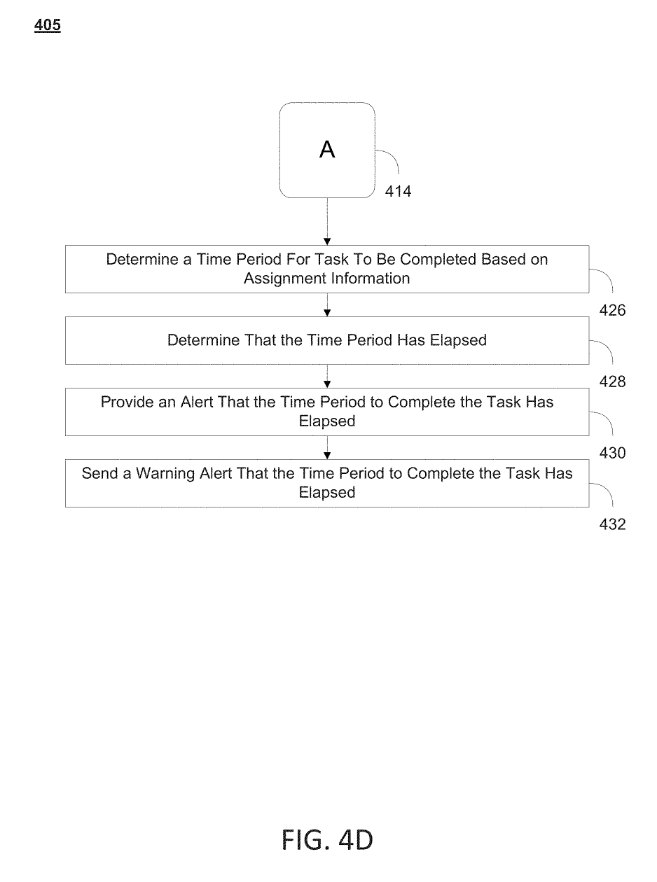

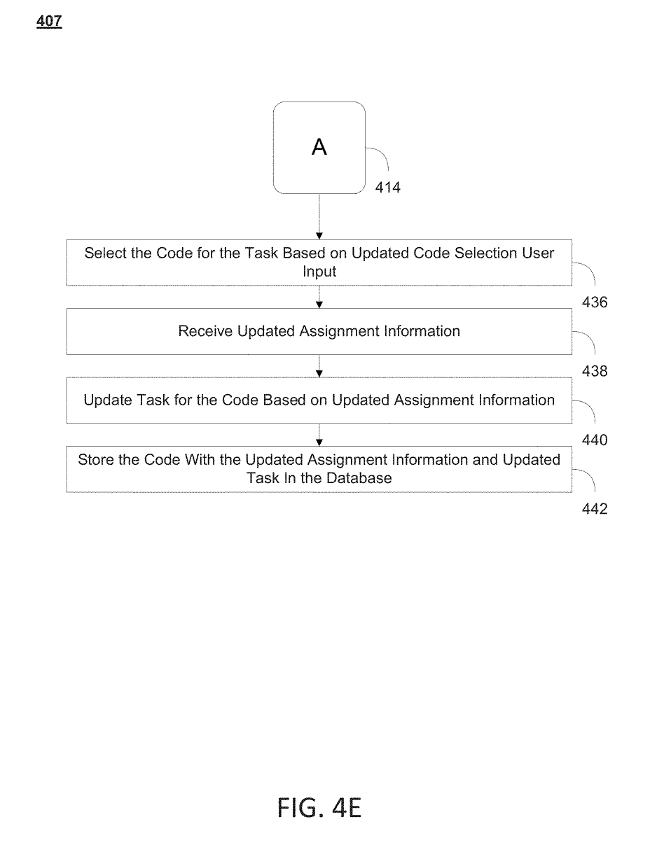

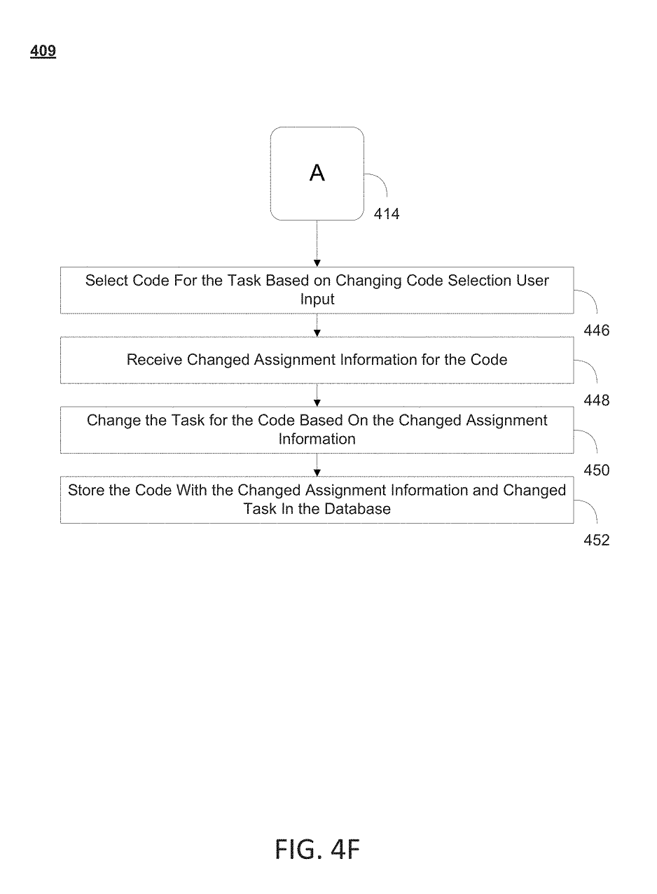

FIGS. 4A-4F are flowcharts of methods for using a code to track task completion, according to some embodiments. Referring to FIG. 4A, the method 400 may include receiving code selection user input by a user device, as shown in block 402. Further, method 400 may include selecting a code, on the user device, for a task based on the code selection input, as shown in block 404. The code may be stored in a code repository. Upon selecting a code, the user may print out or otherwise physically render the code to be placed near where the task is to be completed. In addition, the method 400 may include scanning code using the user device, as shown in block 406. Moreover, the method 400 may include receiving assignment information for the code by the user device, as shown in block 408. Also, the method 400 may include assigning a task for the code based on the assignment information using the user device, as shown in block 410. Thus, the scanning of the code and then providing assignment information (including the task) configures or associates the code to the task. Further, the method 400 may include storing the code with the assignment information and task in a database using the user device, as shown in block 412. The assignment information and task may be in a user interface data structure such that when storing this information into the database, this information may be converted or transformed from a user interface data structure to a database data structure. Further, the code may be in a code data structure but may be converted or transformed into a database data structure. In some embodiments, the code may processed into alphanumeric data or some other data structure such that this data structure is converted or transformed into a database data structure upon storing.

Referring to FIG. 4B, the method 401 may include scanning the code using the user device, as shown in block 416. Further, method 401 may include determining, by the user device, the task based on the code, as shown in block 418. This may include processing the code into alphanumeric data. In addition, method 401 may include storing, by the user device, an indication that the task is complete, as shown in block 420. The indication may be simply toggle a parameter in the database to indicate that the task was complete. For example, the parameter may simply be labeled as “complete?” and can be toggled from “Yes” to “No” as an indication the that the task has been completed. Persons of ordinary skill in the art would understand that other mechanisms may be used in the database to indicate that the task was complete. Moreover, method 401 may include sending a notification, by the user device, that the task has been completed, as shown in block 412.

Referring to FIG. 4C, the method 403 may include scanning the code using the user device, as shown in block 416. Further, method 403 may include determining, by the user device, the task based on the code, as shown in block 418. In addition, method 403 may include determining, by the user device, the task has been completed based on a previous indication stored in the database and assignment information, as shown in block 422. Moreover, method 403 may include providing, by the user device, an alert indicating the task has been completed, as shown in block 424. Accessing any data from the database may include converting or transforming the data from database data structure to another data structure for processing.

Referring to FIG. 4D, the method 405 may include determining, by the user device, a time period for the task to be completed based on the assignment information, as shown in block 426. Further, the method 405 may include determining, by the user device, that the time period has elapsed, as shown in block 428. In addition, the method 405 may include providing, by the user device, as alert that the time period to complete the task has elapsed, as shown in block 430. Moreover, method 405 may include sending, by the user device, a warning alert that the time period to complete the task has elapsed, as shown in block 432. For example, the task may be taking medication daily between 4 pm and 6 pm. Once the time period between 4 pm and 6 pm has elapsed and there is no indication that the task is completed, the alert and warning alert may be provided.

Referring to FIG. 4E, the method 407 may include selecting, by the user device, the code for the task based on updated code selection user input, as shown in block 436. Further, the method 407 may include receiving, by the user device, receiving updated assignment information, as shown in block 438. In addition, the method 407 may include updating, by the user device, the task for the code based on the updated assignment information, as shown in block 440. Moreover, the method 407 may include storing, by the user device, the code with the updated assignment information and updated task in the database, as shown in block 442. For example, a code associated with the task of taking medication once daily between 4 pm-6 pm may be updated to be taken twice daily, once at 8 am-10 am and the other at 4 pm-6 pm.

Referring to FIG. 4F, the method 409 may include selecting, by the user device, the code for the task based on changing code selection user input, as shown in block 446. Further, the method 409 may include receiving, by the user device, changed assignment information for the code, as shown in block 448. In addition, the method 409 may include changing, by the user device, the task for the code based on the changed assignment information, as shown in block 450. Moreover, the method 409 may include storing, by the user device, the code with the changed assignment information and changed task in the database, as shown in block 452. For example, the task associated with the code may be changed such that the task of taking medication associated with the code is changed to watering plants.

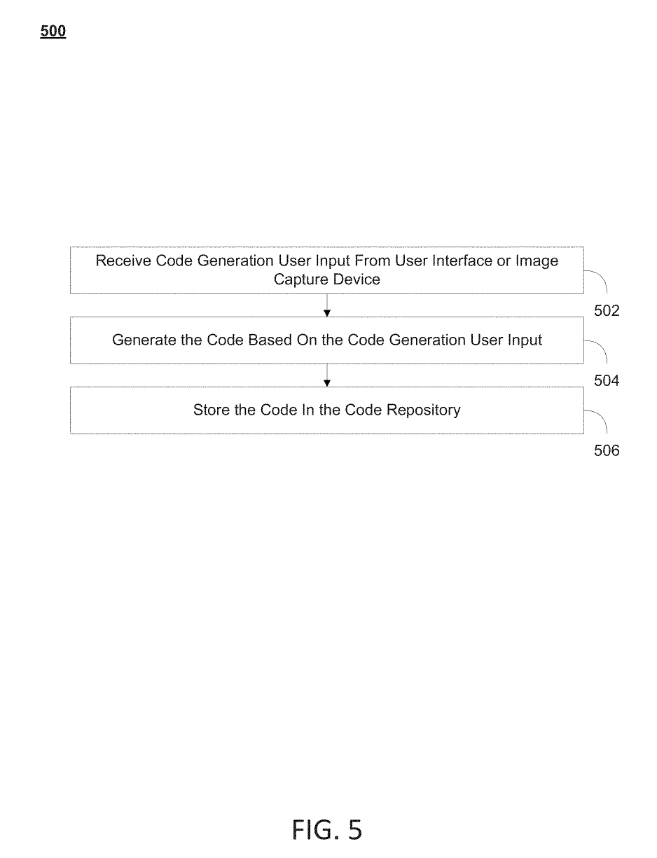

FIG. 5 is a flowchart of a method for using a code to track task completion, according to some embodiments. Method 500 may include receiving, by the user device, code generation user input from a user interface or an image capture device, as shown in block 502. Further, method 500 may include generating, by the user device, the code based on the code generation user input, as shown in block 504. In addition, the method 500 may include storing, by the user device, the code in the code repository, as shown in block 506. For example, the user may capture an image of a container for medication and use this capture image as a code that is assigned the task of taking the medication.

One embodiment may include a personal code scanning device including one or more storage devices, one or more modules including a scanning module, an image capture device, a user interface, one or more processors coupled to the one or more storage devices. The one or more processors implementing the one or more modules may be configured to: (i) receive a code selection user input from the user interface; (ii) select a code for a task from a code repository based on the code selection user input; (iii) scan the code using at least one of a scanning module and the image capture device; (iv) receive assignment information from the user interface for the code; (v) assign a task for the code based on the assignment information; (vi) store the code with the assignment information and task in a database on the one or more storage devices. Further, the one or more processors may be coupled to the one or more storage devices, the one or more processors implementing the one or more modules are further configured to: (a) scan the code using at least one of the scanning module and the image capture device; (b) determine the task based on the code; (c) store an indication that the task is complete in the database. In addition, the one or more processors may be coupled to the one or more storage devices, the one or more processors implementing the one or more modules are further configured to receive user input from the user interface that the task is complete. Moreover, the one or more processors may be coupled to the one or more storage devices, the one or more processors implementing the one or more modules are further configured to: (a) scan the code using at least one of the scanning module and the image capture device; (b) determine the task based on the code; (c) determine that the task has been completed based on a previous indication stored in the database and the assignment information; (d) provide an alert to the user interface indicating the task has been completed. Also, the one or more processors may be coupled to the one or more storage devices, the one or more processors implementing the one or more modules are further configured to send a notification that the task has been completed. Further, the one or more processors may be coupled to the one or more storage devices, the one or more processors implementing the one or more modules are further configured to: (a) determine a time period for the task to be completed based on the assignment information; (b) determine that the time period has elapsed; (c) provide an alert to the user interface that the time period to complete the task has elapsed. In addition, the one or more processors coupled to the one or more storage devices, the one or more processors implementing the one or more modules are further configured to send a warning alert to the user interface that the time period to complete the task has elapsed. The one or more processors coupled to the one or more storage devices, the one or more processors implementing the one or more modules are further configured to: (a) select the code for the task based on updated code selection user input; (b) receive updated assignment information from the user interface for the code; (c) update the task for the code based on the updated assignment information; (d) store the code with the updated assignment information and updated task in the database. In addition, the one or more processors may be coupled to the one or more storage devices, the one or more processors implementing the one or more modules are further configured to: (a) select the code for the task based on changing code selection user input; (b) receive changed assignment information from the user interface for the code; (c) change the task for the code based on the changed assignment information; (d) store the code with the changed assignment information and changed task in the database. Moreover, the one or more processors coupled to the one or more storage devices, the one or more processors implementing the one or more modules are further configured to: (a) receive code generation user input from at least one of the user interface and an image capture device; (b) generate the code based on the code generation user input; (c) store the code in the code repository.

In some embodiments, one or more codes may be assigned to a task. In other embodiments, one or more codes may be used to encrypt or unlock a task. In further embodiments a code may include a biometric parameter. In additional embodiments, there may be the same or different codes in different places that allow a task to be completed by more than one person to facilitate collaboration between people. In other embodiments, the task may be encoded into the code.

Persons of ordinary skill in the art understand that the steps of methods described herein can be implemented in any order and not limited to the order discussed in the present disclosure. Further, persons of ordinary skill in the art understand that any one embodiment disclosed herein may be combined with other embodiments in any manner.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method, comprising:
(a) receiving, by a user computing device, a code selection user input from a user interface of the user computing device;
(b) selecting, by the user computing device, a code for a task from a code repository based on the code selection user input;
(c) scanning the code using at least one of a scanning module and an image capture device of the user computing device;
(d) receiving, by the user computing device, assignment information from the user interface for the code;
(e) assigning, by the user computing device, a task for the code based on the assignment information;
(f) storing, by the user computing device, the code with the assignment information and task in a database.

2. The method of claim 1, further comprising:
(a) scanning the code using at least one of a scanning module of and the image capture device of the user computing device;
(b) determining, by the user computing device, the task based on the code;
(c) storing, by the user computing device, an indication that the task is complete in the database.

3. The method of claim 1, further comprising receiving, by the user interface of the user computing device, user input that the task is complete.

4. The method of claim 1, further comprising:
(a) scanning the code using at least one of the scanning module and the image capture device;
(b) determining, by the user computing device, the task based on the code;
(c) determining, by the user computing device, that the task has been completed based on a previous indication stored in the database and the assignment information;
(d) providing, by the user computing device, an alert to the user interface indicating the task has been completed.

5. The method of claim 4, further comprising sending, by the user computing device through a communication network, a notification that the task has been completed.

6. The method of claim 1, further comprising:
(a) determining, by the user computing device, a time period for the task to be completed based on the assignment information;
(b) determining, by the user computing device, that the time period has elapsed;
(c) providing, by the user computing device, an alert to the user interface that the time period to complete the task has elapsed.

7. The method of claim 6, further comprising sending, by the user computing device through a communication network, a warning alert that the time period to complete the task has elapsed.

8. The method of claim 1, further comprising:
(a) selecting, by the user computing device, the code for the task based on updated code selection user input;
(b) receiving, by the user computing device, updated assignment information from the user interface for the code;
(c) updating, by the user computing device, the task for the code based on the updated assignment information;
(d) storing, by the user computing device, the code with the updated assignment information and updated task in the database.

9. The method of claim 1, further comprising:
(a) selecting, by the user computing device, the code for the task based on changing code selection user input;
(b) receiving, by the user computing device, changed assignment information from the user interface for the code;
(c) changing, by the user computing device, the task for the code based on the changed assignment information;
(d) storing, by the user computing device, the code with the changed assignment information and changed task in the database.

10. The method of claim 1, further comprising:
(a) receiving, by the user computing device, code generation user input from at least one of the user interface and an image capture device;
(b) generating, by the user computing device, the code based on the code generation user input;
(c) storing, by the user computing device, the code in the code repository.

11. A system, comprising:
(a) communication network;
(b) a user computing device coupled to the communication network;
(c) a computer server coupled to the communication network, the computer server having:
(i) one or more storage devices;
(ii) one or more modules including a scanning module;
(iii) one or more processors coupled to the one or more storage devices, the one or more processors implementing the one or more modules configured to:
(A) receive a code selection user input from the user computing device;
(B) select a code for a task from a code repository based on the code selection user input;
(C) receive the scanned code from the user computing device;
(D) receive assignment information for the code;
(E) assign a task for the code based on the assignment information;
(F) store the code with the assignment information and task in a database.

12. The system of claim 11, wherein the one or more processors of the computer server implementing the one or more modules are further configured to:
(a) receive the scanned code from the user computing device;
(b) determine the task based on the code;
(c) store an indication that the task is complete in the database.

13. The system of claim 11, wherein the one or more processors of the computer server implementing the one or more modules are further configured to receive, from the user computing device, user input that the task is complete.

14. The system of claim 11, wherein the one or more processors of the computer server implementing the one or more modules are further configured to:
(a) receive the scanned code from the user computing device;
(b) determine the task based on the code;
(c) determine that the task has been completed based on a previous indication stored in the database and the assignment information;
(d) provide an alert to the user computing device indicating the task has been completed.

15. The system of claim 14, wherein the one or more processors of the computer server implementing the one or more modules are further configured to send a notification that the task has been completed.

16. The system of claim 11, wherein the one or more processors of the computer server implementing the one or more modules are further configured to:
(a) determine a time period for the task to be completed based on the assignment information;
(b) determine that the time period has elapsed;
(c) provide an alert to the user computing device that the time period to complete the task has elapsed.

17. The system of claim 16, wherein the one or more processors of the computer server implementing the one or more modules are further configured to send a warning alert by the user computing device that the time period to complete the task has elapsed.

18. The system of claim 11, wherein the one or more processors of the computer server implementing the one or more modules are further configured to:
(a) receive updated code selection user input from the user computing device;
(b) select the code for the task based on updated code selection user input;
(c) receive updated assignment information from the user computing device for the code;
(d) update the task for the code based on the updated assignment information;
(e) store the code with the updated assignment information and updated task in the database.

19. The system of claim 11, wherein the one or more processors of the computer server implementing the one or more modules are further configured to:
(a) receive changed code selection user input from the user computing device;
(b) select the code for the task based on changing code selection user input;
(c) receive changed assignment information from the user computing device for the code;
(d) change the task for the code based on the changed assignment information;
(e) store the code with the changed assignment information and changed task in the database.

20. The system of claim 11, wherein the one or more processors of the computer server implementing the one or more modules are further configured to:
(a) receive code generation user input from the user computing device;
(b) generate the code based on the code generation user input;
(c) store the code in the code repository.
